(19) United States
(12) Patent Application Publication
(10) Pub. No.: US 2014/0164265 A1
(43) Pub. Date: Jun. 12, 2014

(54) CLINICAL TRIAL ADVERSE EVENT REPORTING SYSTEM

(71) Applicant: ORACLE INTERNATIONAL CORPORATION, Redwood Shores, CA (US)

(72) Inventors: John Andrew KELLEGREW, N. Chelmsford, MA (US); Mark Raymond RINKER, East Bridgewater, MA (US)

(73) Assignee: ORACLE INTERNATIONAL CORPORATION, Redwood Shores, CA (US)

(21) Appl. No.: 13/706,529

(22) Filed: Dec. 6, 2012

(51) Int. Cl. G06Q 30/00

(52) U.S. Cl. CPC G06Q 30/018
USPC 705/317

(57) ABSTRACT

A system is provided that sends data to a safety compliance management system in response to an adverse event. The system receives a first event in response to a first interaction by a user, where the first event indicates that the adverse event is to be reported to the safety compliance management system. The system further receives a second event in response to a second interaction by the user, where the second event indicates that the adverse event is ready to be reported to the safety compliance management system. The system further collects data and sends the collected data to the safety compliance management system.

### FIELD

One embodiment is directed to a computer system, and more particularly, to a computer system that manages clinical data.

### BACKGROUND

Life sciences organizations are generally required to be compliant with global regulations and guidance, including those of the Food and Drug Administration (“FDA”), the European Medicines Agency (“EMEA”), the International Conference on Harmonization of Technical Requirements for Registration of Pharmaceuticals for Human Use (“ICH”), and a myriad of national regulatory authorities. This is especially true for life sciences organizations that conduct clinical trials, such as required clinical trials associated with newly developed drugs.

A clinical trial is a test in medical research and drug development that generates safety and efficacy data for health interventions (e.g., drugs, diagnostics, devices, treatments, or therapy protocols). Such a clinical trial typically involves performing the health intervention on a set of patients that have volunteered for the clinical trial (such as providing a new drug to the set of patients). Once the health intervention is performed on the set of patients, safety and efficacy data is gathered. Such safety and efficacy data can include information about adverse events that occur in response to performing the health intervention on a patient.

An “adverse event” is any adverse change in health or side effect that occurs in a patient who participates in a clinical trial while the patient is receiving the health intervention or within a previously-specified period of time after the health intervention has been completed. Some adverse events can be classified as serious adverse events. A “serious adverse event” is an adverse event that: (1) results in death; (2) is life-threatening; (3) requires in-patient hospitalization or prolongs an existing hospitalization; (4) results in a persistent or significant disability or incapacity; (5) results in a congenital anomaly or birth defect; (6) requires intervention to prevent permanent impairment or damage; or (7) results in another serious medical event that jeopardizes the patient and that may require intervention to prevent one of the other six outcomes. Generally, adverse events are only required to be documented in an annual summary sent to the appropriate regulatory authority, whereas serious adverse events generally must be reported to the appropriate regulatory authority immediately.

### SUMMARY

One embodiment is directed to a system that sends data to a safety compliance management system in response to an adverse event. The system monitors one or more interactions with an adverse event component by a user of an electronic data capture system, where the adverse event component represents the adverse event. The system further receives a first event in response to a first interaction with the adverse event component by the user, where the first event indicates that the adverse event is to be reported to the safety compliance management system. The system further receives a second event in response to a second interaction with the adverse event component by the user, where the second event indicates that the adverse event is ready to be reported to the safety compliance management system. The system further collects data that is stored within the electronic data capture system. The system further sends the collected data to the safety compliance management system.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a block diagram of a system that can implement an embodiment of the invention.

FIG. 2 illustrates a block diagram of an integrated system that includes components of an electronic data capture system and components of a safety compliance management system, according to an embodiment of the invention.

FIG. 3 illustrates an example user interface of an electronic data capture system that can display an adverse event form, according to an embodiment of the invention.

FIG. 4 illustrates a flow diagram of a process for sending data from an electronic data capture system to a safety compliance management system in response to an adverse event, according to an embodiment of the invention.

FIG. 5 illustrates a flow diagram of a process for sending data in response to an adverse event, according to an embodiment of the invention.

FIG. 6 illustrates a flow diagram of the functionality of an adverse event data module, according to an embodiment of the invention.

### DETAILED DESCRIPTION

In one embodiment, an electronic data capture system can be integrated with a safety compliance management system. The electronic data capture system can capture data associated with an adverse event, and can monitor whether the adverse event is classified as a serious adverse event. Alternatively, the electronic data capture system can monitor whether the adverse event is an adverse event that is required to be reported to a regulatory authority, even if the adverse event is not classified as a serious adverse event. The electronic data capture system can further collect safety data that is stored within the electronic data capture system, where safety data is defined as a subset of the data stored within the electronic data capture system, and safety data is associated with an adverse event. The electronic data capture system can further receive an indication that the adverse event is ready to be reported to the regulatory authority. In response to the indication, the electronic data capture system can send the collected safety data to a safety compliance management system in near real-time. In an alternate embodiment, the electronic data capture system can automatically send the collected safety data to the safety compliance management system after a pre-defined time interval, if no indication is received.

As understood by one of ordinary skill in the art, “near real-time,” in telecommunications and computing, refers to a time delay introduced by automated data processing or network transmission. Thus, in the embodiment where the collected data is sent in near real-time to a safety compliance management system, in response to a reception of an indication that an adverse event is ready to be reported, the collected safety data is sent at the time the indication is received, in addition to any time delay associated with processing an instruction to send the collected safety data, and in addition to any time delay associated with transmitting the data to the safety compliance management system.

In some previous clinical trial systems, the communication of safety data from a capture system that captures the safety data to a reporting system that reports the safety data to a regulatory authority was generally a manual process. For example, an individual would have to e-mail or fax the safety data to another individual, where the other individual would have to manually enter the data into the reporting system. In situations where there was an automatic integration of these two systems, the integration involved data extracts that were run at specified intervals, such as an overnight batch process that only ran at night. Thus, the safety data was not provided in near-real time. As described below, embodiments of the invention can provide a true integration, where safety data can be sent from an electronic data capture system to a safety compliance management system in near real-time.

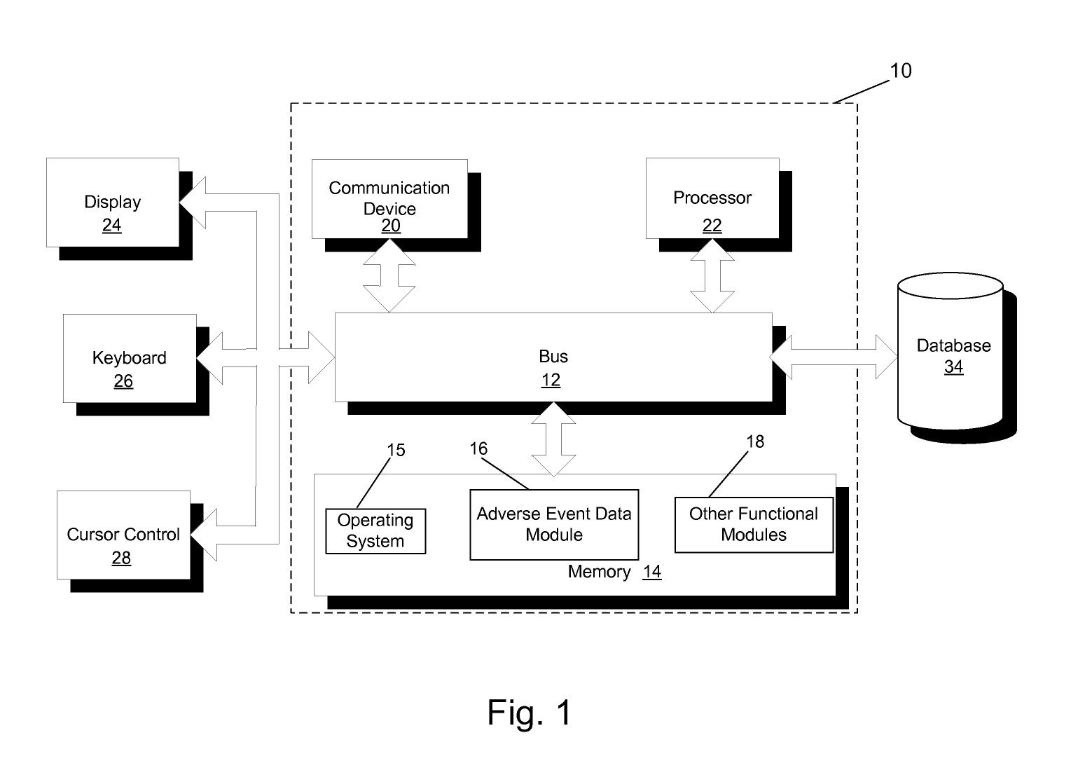

FIG. 1 illustrates a block diagram of a system 10 that can implement one embodiment of the invention. System 10 includes a bus 12 or other communications mechanism for communicating information between components of system 10. System 10 also includes a processor 22, operatively coupled to bus 12, for processing information and executing instructions or operations. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer-readable medium. System 10 further includes a communication device 20, such as a network interface card or other communications interface, to provide access to a network. As a result, a user may interface with system 10 directly, or remotely through a network or any other method.

A computer-readable medium may be any available medium that can be accessed by processor 22. A computer-readable medium may include both a volatile and nonvolatile medium, a removable and non-removable medium, a communication medium, and a storage medium. A communication medium may include computer readable instructions, data structures, program modules or other data in a modulated data signal such as a carrier wave or other transport mechanism, and may include any other form of information delivery medium known in the art. A storage medium may include RAM, flash memory, ROM, erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Processor 22 can also be operatively coupled via bus 12 to a display 24, such as a Liquid Crystal Display (“LCD”). Display 24 can display information to the user. A keyboard 26 and a cursor control device 28, such as a computer mouse, can also be operatively coupled to bus 12 to enable the user to interface with system 10.

According to one embodiment, memory 14 can store software modules that may provide functionality when executed by processor 22. The modules can include an operating system 15, an adverse event data module 16, as well as other functional modules 18. Operating system 15 can provide an operating system functionality for system 10. Adverse event data module 16 can provide functionality for sending data to a safety compliance management system in response to an adverse event, as will be described in more detail below. In certain embodiments, adverse event data module 16 can comprise a plurality of modules, where each module provides specific individual functionality for sending data to a safety compliance management system in response to an adverse event. System 10 can also be part of a larger system. Thus, system 10 can include one or more additional functional modules 18 to include the additional functionality. For example, functional modules 18 may include modules that provide additional functionality, such as a module of the “Oracle Health Sciences InForm Global Trial Management (“GTM”)” product from Oracle Corporation, or a module of the “Oracle Argus Safety” product from Oracle Corporation.

Processor 22 can also be operatively coupled via bus 12 to a database 34. Database 34 can store data in an integrated collection of logically-related records or files. Database 34 can be an operational database, an analytical database, a data warehouse, a distributed database, an end-user database, an external database, a navigational database, an in-memory database, a document-oriented database, a real-time database, a relational database, an object-oriented database, or any other database known in the art.

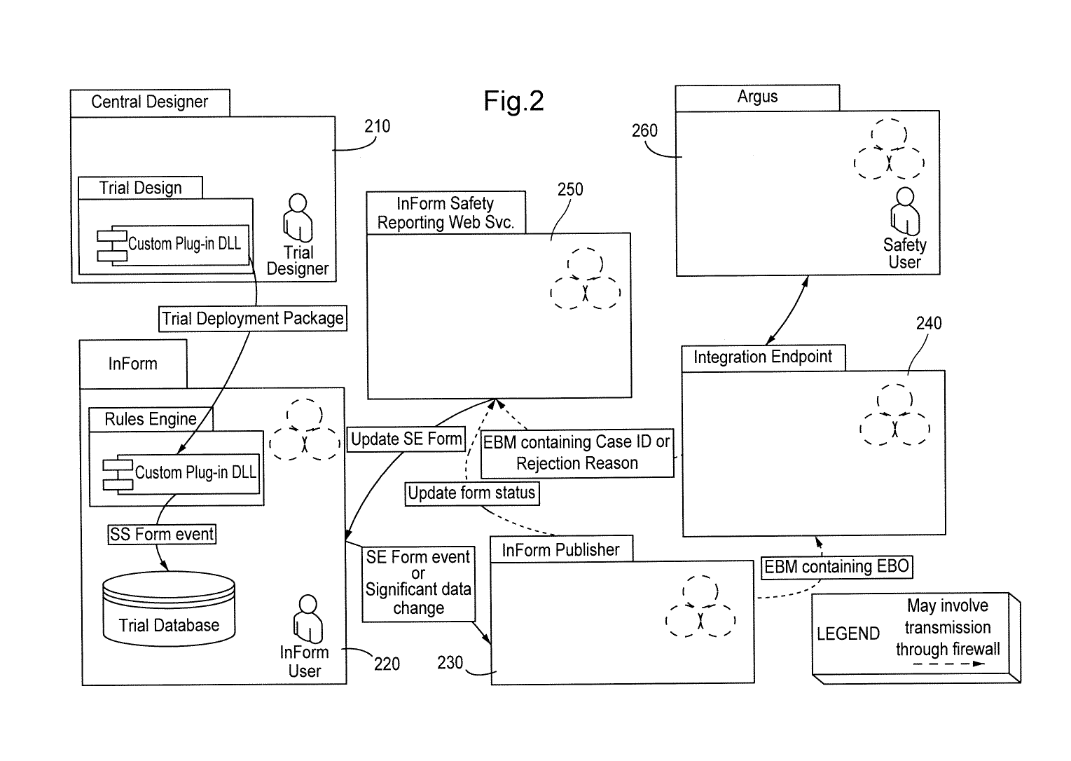

FIG. 2 illustrates a block diagram of an integrated system that includes components of an electronic data capture system and components of a safety compliance management system, according to an embodiment of the invention. As previously described, an electronic data capture system is a system configured to electronically capture data, where, in certain embodiments, the data can be associated with one or more clinical trials. An example of an electronic data capture system is the “Oracle Health Sciences InForm Global Trial Management (“GTM”)” product from Oracle Corporation.” As also previously described, a safety compliance management system is a system configured to manage and report safety data to a regulatory authority, where, in certain embodiment, the data can be associated with one or more clinical trials. An example of a safety compliance management system is the “Oracle Argus Safety” product from Oracle Corporation. In one embodiment, each component can include a module, or a collection of modules, that is configured to perform functionality described below, when the component is executed by a processor.

According to the embodiment, the electronic data capture system includes a designer component 210, an electronic data capture component 220, a publisher component 230, an integration component 240, and a report component 250. Further, according to the embodiment, the safety compliance management system includes a safety compliance management component 260. In one embodiment, each component can include a module, or a collection of modules, that is configured to perform functionality described below, when the component is executed by a processor.

Designer component 210 is a component that provides a design environment that allows a user of the electronic data capture system to create one or more clinical trial components, where a clinical trial component can be displayed within a user interface of the electronic data capture system, and where the clinical trial component enables the electronic data capture system to capture data associated with a clinical trial. An example of a clinical trial component is a clinical trial form.

The clinical trial component can display one or more data fields of a logical schema within the user interface, and the clinical trial component can allow a user to interact with the clinical trial component, by, as an example, entering one or more data values for each of the one or more data fields. The clinical trial component can further store the one or more entered data values for each of the one or more data fields within a database of the electronic data capture system. A logical schema is a collection of one or more data sets, where each data set includes one or more data fields, and where each data field includes zero or more data values.

Designer component 210 can further allow a user to create one or more workflows, where a workflow can be associated with a clinical trial component, and where the workflow can include one or more processes that are performed upon an interaction within the clinical trial component by a user of the electronic data capture system. Designer component 210 can also allow a user to create one or more rules, where a rule can be associated with a clinical trial component, such as a clinical trial form, and where a rule can be an executable process that performs specified functionality. A rule can be executed upon an interaction within a clinical trial component by a user of the electronic data capture system. Further, a rule can invoke one or more functions of a custom plug-in dynamically linked library (“DLL”) where the custom-plug in DLL can be stored within designer component 210. An example of designer component 210 is an “Oracle Central Designer” module from Oracle Corporation.

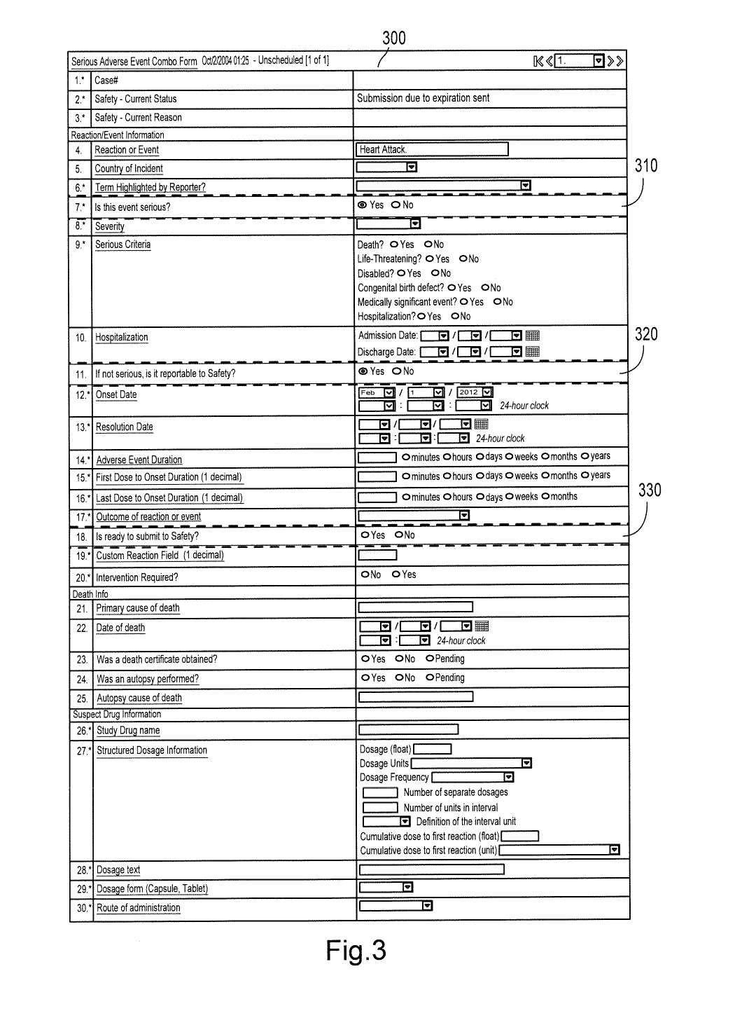

According to an embodiment, a user can create an adverse event component, such as an adverse event form, within designer component 210, where the adverse event component can be used by a user of the electronic data capture system to report an adverse event associated with a clinical trial, and thus, where the adverse event component can represent the adverse event associated with the clinical trial. An adverse event component can also be identified as a “safety event component.” Similarly, an adverse event form can also be identified as a “safety event form.” According to the embodiment, the adverse event component can be associated with a logical schema, where the adverse event component can display one or more data fields of the associated logical schema, and the adverse event component can allow a user to interact with the adverse event component, by, as an example, entering one or more data values for each of the one or more data fields. The adverse event component can further store the one or more entered data values for each of the one or more data fields within a database of the electronic data capture system. An example of an adverse event component (i.e., an adverse event form) is described below in relation to FIG. 3.

Further, according to the embodiment, designer component 210 can allow a user to create one or more additional logical schemas, where the logical schemas are associated with data that is stored within the electronic data capture system. An example logical schema is a “safety data logical schema.” A safety data logical schema can define (and include) a subset of the data stored within the electronic data capture system, where the subset of the data is identified as “safety data.” “Safety data” can include data associated with a clinical trial that is to be reported to a safety compliance management system when a serious adverse event (or an adverse event that otherwise is to be reported to the safety compliance management system) occurs. Thus, safety data can include one or more data fields that can be mapped to an enterprise business object (“EBO”) where the EBO can be sent from the electronic data capture system to the safety compliance management system within an enterprise business message (“EBM”) in response to a serious adverse event (or an adverse event that is to be reported), where the EBO stores the data values that are stored in the one or more data fields. In certain embodiments, safety data can include data entered in an adverse event component by a user. According to the embodiment, the subset of the data (i.e., the one or more data fields) identified as safety data can be defined by a user of the electronic data capture system via the safety data logical schema.

Another example logical schema is a “significant safety data logical schema.” A significant safety data logical schema can define (and include) a subset of the safety data stored within the electronic data capture system, where the subset of the safety data is identified as “significant safety data.” Significant safety data can include the safety data that is to be monitored after the safety data is sent to a safety compliance management system in response to a serious adverse event (or an adverse event that is to be reported to the safety compliance management system). Thus, significant safety data can include one or more data fields that are defined as significant data fields and the one or more data values associated with the significant data fields. According to the embodiment, a change in at least one data field of the significant safety data can initiate a resending of an EBO that includes the safety data within an EBM. Also according to the embodiment, the one or more data fields identified as significant data fields can be defined by a user of the electronic data capture system via the significant safety data logical schema.

Electronic data capture component 220 is a component that can store data associated with a clinical trial within a database of the electronic data capture system, such as a trial database. The data can be associated with one or more logical schemas, where the one or more logical schemas can be created within designer component 210, and where the one or more logical schemas can also be exported to electronic data capture component 220 as a trial deployment package. Electronic data capture component 220 can also store one or more clinical trial components (such as an adverse event component), where the one or more clinical trial components can also be created within designer component 210, and where the one or more clinical trial components can also be exported to electronic data capture component 220 as a trial deployment package. Electronic data capture component 220 can further store one or more rules associated with one or more clinical trial components, where the one or more rules can also be created within designer component 210, can also be exported to electronic data capture component 220 as a trial deployment package, and can be stored within a rules engine. In one embodiment, the one or more rules can invoke one or more functions of one or more custom plug-in DLLs. According to the embodiment, electronic data capture component 220 can display one or more clinical trial components (such as an adverse event component) within a user interface of electronic data capture component 220. A user can interact with the user interface of electronic data capture component 220 through one or more interactions. Such an interaction can include the entering of data within a clinical trial component that is displayed within the user interface of electronic data capture component 220. An example of electronic data capture component 220 is an “Oracle InForm” module from Oracle Corporation.

According to an embodiment, data associated with a clinical trial can be entered into an electronic data capture system by a user using electronic data capture component 220. Further, according to the embodiment, a user can report an adverse event by interacting with an adverse event component using electronic data capture component 220. The user can indicate that the adverse event is a serious adverse event (or an adverse event that is to be reported to a safety compliance management system) by selecting a first radio button (or other displayable element) within the adverse event component (or by otherwise interacting with the adverse event component). As an example, the user, in his or her professional medical judgment, can review the details of the adverse event (which can be captured within the adverse event component) and can determine that the adverse event should be classified as a serious adverse event. Electronic data capture component 220 can monitor the adverse event component, and thus, monitor the user's interaction with the adverse event component. In response to selecting the first radio button (or other interaction), a first event is created and sent to a queue within electronic data capture component 220. In one embodiment, a first rule can be created and associated with the first radio button of the adverse event component, where the first rule creates the first event and sends the first event to the queue in response to a user selecting the first radio button. The first rule can invoke one or more functions of a custom plug-in DLL.

In an alternate embodiment, a user can configure the electronic data capture system so that every adverse event is a serious adverse event (or an adverse event that is to be reported to a safety compliance management system). In this alternate embodiment, in response to the user entering data within an adverse event component, the first event is created and sent to the queue within electronic data capture component 220.

The user can further indicate that the adverse event is ready to be reported to the safety compliance management system by selecting a second radio button (or other displayable element) within the adverse event component (or by otherwise interacting with the adverse event component). As an example, the user, in his or her professional medical judgment, can review the details of the adverse event (which can be captured within the adverse event component) and can determine that, while the adverse event does not qualify as a serious adverse event, the adverse event should be reported to an appropriate regulatory authority for some other reason. In some scenarios, the user that selects the first radio button, and the user that selects the second radio button, might be two separate users. For example, a nurse may select the first radio button, and a doctor may select the second button after reviewing the data entered within the adverse event component by the nurse. Electronic data capture component 220 can monitor the adverse event component, and thus, monitor the user's interaction with the adverse event component. In response to selecting the second radio button (or other interaction), a second event is created and sent to a queue within electronic data capture component 220. In response to the second event being placed in the queue, electronic data capture component 220 can send an indication to publisher component 230, where the indication indicates that the safety data is to be sent to a safety compliance management system. In one embodiment, a second rule can be created and associated with the second radio button of the adverse event component, where the second rule creates the second event and sends the second event to the queue in response to a user selecting the second radio button. The second rule can invoke one or more functions of a custom plug-in DLL.

In an alternate embodiment, after safety data stored within the electronic data capture system has been sent to the safety management compliance system, using electronic data capture component 220, a user can change the safety data stored within the electronic data capture system that has been sent to the safety management compliance system. Such a change can include a change to one or more data values associated with at least one data field identified as a significant data field. A change to a data value can include an insertion of a data value into a data field, a deletion of a data value from a data field, or a modification of a data value of a data field.

Publisher component 230 is a component that can collect safety data and send the safety data to integration component 240, where the safety data is ultimately sent to a safety compliance management system. According to the embodiment, in response to a second event being placed in a queue by electronic data capture component 220, where the second event indicates that the adverse event is ready to be reported to the safety compliance management system, publisher component 230 can collect safety data stored within the electronic data capture system and send the collected safety data to integration component 240, where the collected safety data is ultimately sent to a safety management compliance system. The collection and the sending of the safety data can occur in near real-time.

Alternately, in response to a first event being placed in a queue by electronic data capture component 220, where the first event indicates that the adverse event is to be reported to the safety compliance management system, a timer can be initiated to a pre-defined time interval (such as, for example, five minutes). The pre-defined time interval can be any time interval, up to a maximum time interval of 1400 minutes. When the pre-defined time interval elapses before the second event is placed in the queue, publisher component 230 can collect safety data stored within the electronic data capture system and send the collected safety data to integration component 240, where the collected safety data is ultimately sent to the safety management compliance system.

In an alternate embodiment, after safety data stored within the electronic data capture system has been sent to the safety management compliance system, publisher component 230 can monitor the safety data. In response to a change to one or more data values associated with at least one data field identified as a significant data field, publisher component 230 can collect safety data stored within the electronic data capture system and send the collected safety data to integration component 240, where the collected safety data is ultimately sent to the safety management compliance system. For example, a data field associated with the eye color of a patient may not be identified as a significant data field, and thus, a change to one or more data values associated with this data field, such as a change from a data value of “blue” to a data value of “brown,” may not trigger a resending of the safety data. However, a data field associated with a health status of the patient may be identified as a significant data field, and thus, a change to one or more data values associated with this data field, such as a change from a data value of “hospitalized” to a data value of “died,” may trigger a resending of the safety data. In one embodiment, publisher component 230 can monitor the safety data based on a time interval specified by a configuration parameter (such as 700 minutes or 1400 minutes), where, at each time interval (such as every 700 minutes or every 1400 minutes), publisher component 230 can check whether the safety data has been changed. The time interval can be any time interval, up to a maximum time interval of 1400 minutes.

According to the embodiment, where publisher component 230 sends the collected safety data to integration component 240, publisher component 230 can create an EBO and store the collected safety data within the EBO. Publisher component 230 can then send the EBO to integration component 240 within an EBM. This can be done for both initially sending the safety data to integration component 240, either in response to receiving the second event, or in response to the pre-specified time interval of the timer elapsing before the second event is received, and for resending the safety data to integration component 240 in response to a change to at least one significant data field. In one embodiment, publisher component 230 can further send an instruction to report component 250, where the instruction is an instruction to update the status of the adverse event component. An example of publisher component 230 is an “Oracle InForm Publisher” module from Oracle Corporation.

Integration component 240 is a component that integrates an electronic data capture system and a safety compliance management system. Integration component 240 can receive safety data and send the safety data to safety compliance management component 260. Integration component 240 can further receive a status indication from safety compliance management component 260, where the status indication indicates that the safety data has either been accepted or rejected. Integration component 240 can further send the status indication to report component 250. An example of integration component 240 is an “integration endpoint” from Oracle Corporation, where an integration endpoint is a communication channel from where predefined data is sent or received.

Report component 250 is a component that can update an adverse event component of electronic data capture component 220 based on the sending of safety data to integration component 240 by publisher component 230, or based on the acceptance or rejection of the safety data by safety compliance management component 260. An example of report component is an “Oracle InForm Safety Web Service” module from Oracle Corporation.

Safety compliance management component 260 is a component that receives safety data from integration component 240, and can determine whether the safety data is to be reported to a regulatory authority. If the safety data is to be reported to a regulatory authority, safety compliance management component 260 can send an indication to report component 250 that the safety data is accepted. In an embodiment, the indication that the safety data is accepted can include a case identity, where the case identity is an identity of a case that is successfully created within the safety compliance management system based on the safety data. If the safety data is not to be reported to the regulatory authority, safety compliance management component 260 can send an indication to report component 250 that the safety data is rejected. In an embodiment, the indication that the safety data is rejected can include one or more reasons for rejection. The one or more reasons for rejection can be used to modify the safety data stored within the electronic data capture system, so that the safety data can be resubmitted to the safety compliance management system.

FIG. 3 illustrates an example user interface of an electronic data capture system that can display an adverse event form 300, according to an embodiment of the invention. According to the embodiment, adverse event form 300 (an example of an adverse event component) can be associated with a logical schema, where adverse event form 300 can display one or more data fields of the associated logical schema, and where adverse event form 300 can allow a user to interact with adverse event form 300, by, as an example, entering one or more data values for each of the one or more data fields. Adverse event form 300 can further store the one or more entered data values for each of the one or more data fields within a database of the electronic data capture system. Adverse event form 300 can be used by a user of the electronic data capture system to report an adverse event.

In the illustrated embodiment, adverse event form 300 displays one or more data fields of data associated with an adverse event. Such data fields can include, for example, a description of the adverse event, a severity of the adverse event, a duration of the adverse event, patient death information (if the adverse event resulted in a patient death), patient hospitalization information (if the adverse event resulted in the hospitalization of a patient), etc. A user of the electronic data capture system can interact with adverse event form 300. Such an interaction can include entering one or more data values for one or more data fields displayed within adverse event form 300. One or more data values can be entered by a user “clicking” on a text box displayed for a data field, and by entering the one or more data values within the text box. One or more data values can also be entered by a user “clicking” on a radio button, check box, or other displayable element displayed for a data field.

According to an embodiment, a user of the electronic data capture system can select radio button 310 to indicate that the adverse event is a serious adverse event. As previously described, the selection of radio button 310 can initiate a timer within the electronic data capture system to a pre-defined interval, where the electronic data capture system automatically collects safety data stored within the electronic data capture system and automatically sends the safety data to a safety compliance management system when the pre-defined interval of the timer elapses.

According to the embodiment, the user of the electronic data capture system can alternately select radio button 320 to indicate that the adverse event (while not a serious adverse event) is to be reported to a safety compliance management system. Similar to the selection of radio button 310, the selection of radio button 320 can initiate a timer within the electronic data capture system to a pre-defined interval, where the electronic data capture system automatically collects safety data stored within the electronic data capture system and automatically sends the safety data to a safety compliance management system when the pre-defined interval of the timer elapses.

Further, according to the embodiment, once the user has either selected radio button 310 or radio button 320, and the user is ready for the safety data to be sent to the safety compliance management system, the user can select radio button 330 to indicate that the adverse event is ready to be reported to the safety compliance management system. As previously described, the selection of radio button 330 can cause the electronic data capture system to collect safety data stored within the electronic data capture system and send the safety data to the safety compliance management system in near real-time.

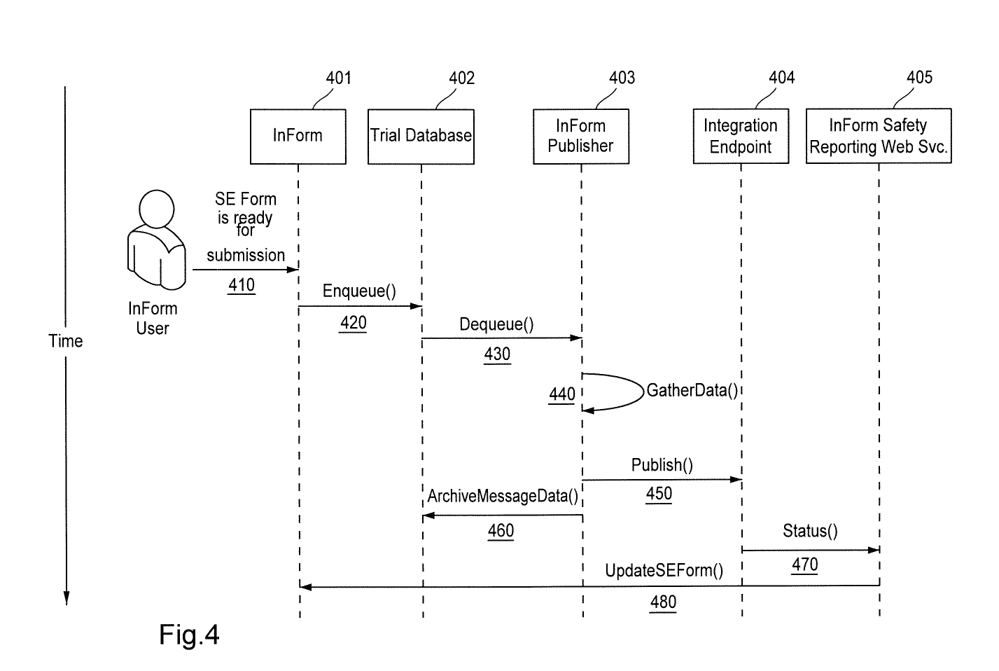

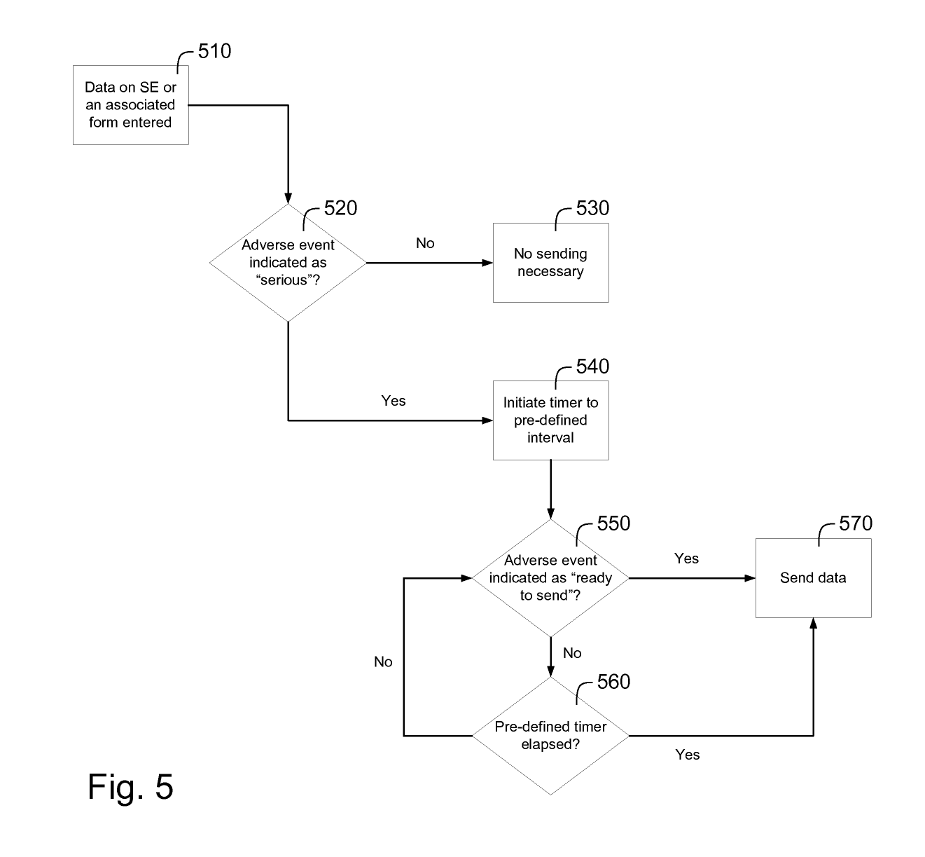

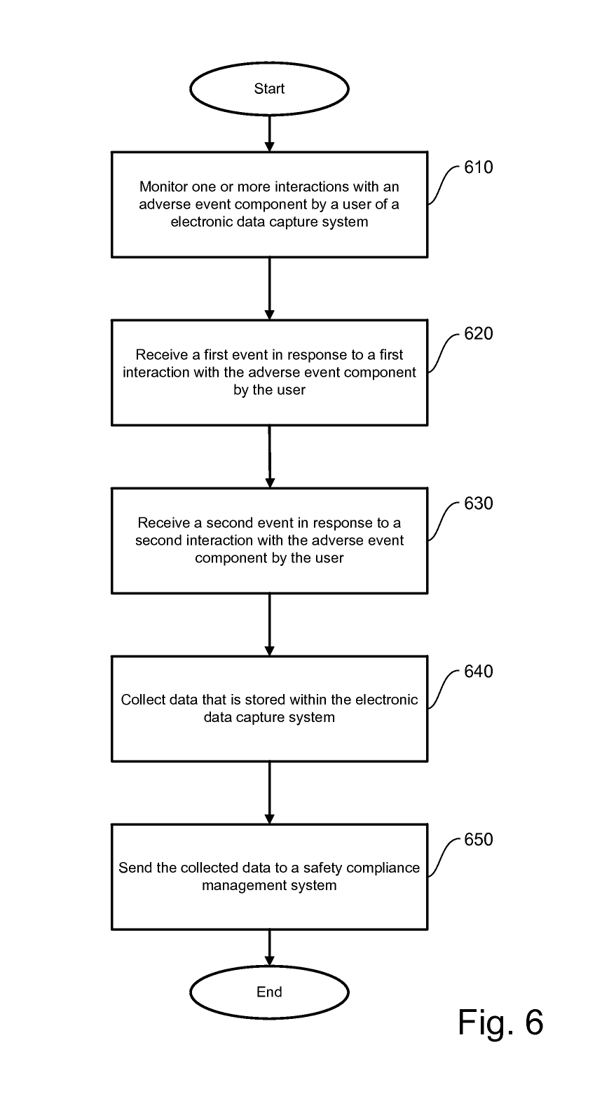

FIG. 4 illustrates a flow diagram of a process for sending data from an electronic data capture system to a safety compliance management system in response to an adverse event, according to an embodiment of the invention. In one embodiment, the functionality of the flow diagram of FIG. 4 (described below), as well as the functionality of the flow diagrams of FIGS. 5 and 6 (also described below), are each implemented by software stored in a memory or some other computer-readable or tangible medium, and executed by a processor. In other embodiments, each functionality may be performed by hardware (e.g., through the use of an application specific integrated circuit (“ASIC”), a programmable gate array (“PGA”), a field programmable gate array (“FPGA”), etc.), or any combination of hardware and software.

In the illustrated embodiment, the process involves electronic data capture component (identified in FIG. 4 as “InForm”) 401, trial database 402 (which can be stored within electronic data capture component 401, according to an embodiment), publisher component (identified in FIG. 4 as “InForm Publisher”) 403, integration component (identified in FIG. 4 as “Integration Endpoint”) 404, and reporting component (identified in FIG. 4 as “InForm Safety Reporting Web Svc.”) 405. According to the embodiment, these components are similar to the respective components illustrated in FIG. 2.

The flow beings and proceeds to 410. At 410, a user of an electronic data capture system (identified in FIG. 4 as an “Inform User”) indicates that an adverse event form (or safety event form, identified in FIG. 4 as “SE form”) is ready for submission. In one embodiment, the user can indicate that the adverse event form is ready for submission by selecting a radio button (or other displayable element) within the adverse event form that indicates that the adverse event represented by the adverse event form is ready to be reported to the safety compliance management system (or by otherwise interacting with the adverse event form). In an alternate embodiment, rather than the user indicating that the adverse event form is ready for submission, electronic data capture component 401 can automatically determine that the adverse event form is ready for submission after a pre-determined time interval for a timer elapses, where the timer is initiated in response to the user selecting a radio button within the adverse event form that indicates that the adverse event represented by the adverse event form is ready to be reported to the safety compliance management system (or by otherwise interacting with the adverse event form). The flow proceeds to 420.

At 420, electronic data capture component 401 sends an event to a queue stored within trial database 402. The event indicates that the adverse event represented by the adverse event form is ready to be reported to the safety compliance management system. The flow proceeds to 430.

At 430, the event is retrieved from the queue stored within trial database 402 and sent to publisher component 403. The flow proceeds to 440.

At 440, publisher component 403 collects safety data stored within the electronic data capture system. According to an embodiment, safety data can include a subset of the data stored within the electronic data capture system, where the subset is defined by a safety data logical schema. The flow proceeds to 450.

At 450, publisher component 403 publishes the collected safety data by sending the collected safety data to integration component 404. According to an embodiment, integration component 404 can ultimately send the collected safety data to the safety compliance management system. In one embodiment, publisher component 403 creates a message (such as an EBM) that includes a business object (such as an EBO), stores the collected safety data within the business object of the message, and sends the message to integration component 404. The flow proceeds to 460.

At 460, publisher component 403 archives a log that indicates that the message was sent to integration component 404, where the log can indicate that the message is an initial submission. Publisher component 403 can archive the log by storing the log within trial database 402. The flow proceeds to 470.

At 470, integration component 404 sends a status indication that it receives from the safety compliance management system to report component 405. According to an embodiment, the status indication can indicate that the safety data has either been accepted or rejected. The flow proceeds to 480.

At 480, report component 405 updates the adverse event form of electronic data component 401. According to an embodiment, report component 405 can update the adverse event form based on publisher component 403 sending the safety data to integration component 404. Also according to the embodiment, report component 405 can update the adverse event form based on the status indication that integration component 404 sends to report component 405. The flow then ends.

FIG. 5 illustrates a flow diagram of a process for sending data in response to an adverse event, according to an embodiment of the invention. The flow begins and proceeds to 510. At 510, data is entered on an adverse event form (or safety event form, identified in FIG. 5 as “SE form”), that represents an adverse event. In one embodiment, data can be entered on the adverse event form by entering one or more data values for one or more data fields displayed within the adverse event form. The flow proceeds to 520.

At 520, it is determined whether the adverse event is indicated as a serious adverse event within the adverse event form. In one embodiment, a user can indicate that the adverse event is a serious adverse event by selecting a first radio button (or other displayable element) within the adverse event form. In other embodiments, a user can indicate that the adverse event is a serious adverse event by otherwise interacting with the adverse event form. In an alternate embodiment, it can be determined whether the adverse event is to be reported within the adverse event form, even if the adverse event is not a serious adverse event. In one embodiment, a user can indicate that the adverse event is to be reported by selecting a second radio button (or other displayable element) within the adverse event form. In other embodiments, a user can indicate that the adverse event is to be reported by otherwise interacting with the adverse event form.

If it is determined that the adverse event is not indicated as a serious adverse event (or, in other embodiments, if it is determined that the adverse event is not to be reported), the flow proceeds to 530. If it is determined that the adverse event is indicated as a serious adverse event (or in other embodiments, if it is determined that the adverse event is to be reported), the flow proceeds to 540.

At 530, safety data is not sent to a safety compliance management system. This is either because the adverse event has not been indicated as a serious adverse event, or because the adverse event has not been indicated as an adverse event that is to be reported. The flow then ends.

At 540, a timer is initiated to a pre-defined time interval. According to the embodiment, if the pre-defined time interval elapses before a user indicates that the adverse event is ready to be reported, the safety data can be automatically sent to the safety management compliance system. The flow proceeds to 550.

At 550, it is determined whether the adverse event is indicated as ready to be reported within the adverse event form. In one embodiment, a user can indicate that the adverse event is ready to be reported by selecting a second radio button (or other displayable element) within the adverse event form. In other embodiments, a user can indicate that the adverse event is ready to be reported by otherwise interacting with the adverse event form.

If it is determined that the adverse event is not indicated as ready to be reported, the flow proceeds to 560. If it is determined that the adverse event is indicated as ready to be reported, the flow proceeds to 570.

At 560, it is determined whether the pre-defined interval of the timer has elapsed. According to the embodiment, a user has a duration of the pre-defined interval to interact with the adverse event form. Such interaction can include entering data within the adverse event form.

If it is determined that the pre-defined interval of the timer has not elapsed, the flow loops back to 550. If it is determined that the pre-defined interval of the timer has elapsed, the flow proceeds to 570.

At 570, safety data is sent to the safety management compliance system. In one embodiment, if it is determined that the adverse event is indicated as ready to be reported, then the safety data can be sent to the safety management compliance system in response to the indication of the adverse event as ready to be reported, in near real-time. In an alternate embodiment, if it is determined that the pre-defined interval of the time has elapsed, then the safety data can be automatically sent to the safety management compliance system in response to the pre-defined time interval elapsing. The flow then ends.

FIG. 6 illustrates a flow diagram of the functionality of an adverse event data module (such as adverse event data module 16 of FIG. 1), according to an embodiment of the invention. The flow begins and proceeds to 610. At 610, one or more interactions with an adverse event component by a user of an electronic data capture system are monitored. The adverse event component can represent an adverse event. In certain embodiments, the adverse event component is an adverse event form that is displayed within a user interface of the electronic data capture system. In these embodiments, each interaction of the one or more interactions is an entering of data within the adverse event form by the user. The flow proceeds to 620.

At 620, a first event is received in response to a first interaction with the adverse event component by the user. The first event can indicate that the adverse event is to be reported to a safety compliance management system. In certain embodiments, a timer can be initiated to a pre-defined time interval in response to the reception of the first event. Also, in certain embodiments where the adverse event component is an adverse event form, the first interaction can include selecting a first displayable element displayed within the adverse event form. The selection of the first displayable element can indicate that the adverse event is to be reported to the safety compliance management system. The selection of the first displayable element can further indicate that the adverse event is a serious event. The flow proceeds to 630.

At 630, a second event is received in response to a second interaction with the adverse event component by the user. The second event can indicate that the adverse event is ready to be reported to the safety compliance management system. In certain embodiments where the adverse event component is an adverse event form, the second interaction can include selecting a second displayable element displayed within the adverse event form. The selection of the second displayable element can indicate that the adverse event is ready to be reported to the safety compliance management system. The flow proceeds to 640.

At 640, data that is stored within the electronic data capture system is collected. In certain embodiments, the collected data can be safety data, where the safety data is defined as a subset of the data stored within the electronic data capture system. The safety data can be associated with the adverse event. In certain embodiments, a logical schema can be created that defines the subset of the data stored within the electronic data capture system. Additionally, in certain embodiments, the data can include data associated with a clinical trial, and the adverse event can be an adverse event associated with the clinical trial. The flow proceeds to 650.

At 650, the collected data is sent to the safety compliance management system. In certain embodiments, the collected data can be sent to the safety compliance management system when the pre-defined time interval of the time elapses before the second event is received. In other embodiments, the collected data can be sent to the safety compliance management system in near real-time in response to receiving the second event. The flow then ends.

Thus, an integrated system can be provided, where the integrated system can either send safety data in response to an indication that safety data is ready to be sent in near real-time, or automatically send safety data after a pre-defined time interval, if no indication is received. According to certain embodiments, this integration can reduce time between when a serious adverse event is entered into an electronic data capture system and the time the serious adverse event is reported to a safety group. For example, data can be sent to the safety group within minutes of a serious adverse event being entered into the electronic data capture system. This can happen even if a user forgets to indicate that the data is ready to send. This can replace a manual or batch extract process which can take hours, and this can prevent regulatory filing requirements from being missed due to a failure to send the data to the safety group.

The features, structures, or characteristics of the invention described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present invention. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the invention as discussed above may be practiced with steps in a different order, and/or with elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A computer-readable medium having instructions stored thereon that, when executed by a processor, cause the processor to send data to a safety compliance management system in response to an adverse event, the sending comprising:
monitoring one or more interactions with an adverse event component by a user of an electronic data capture system, wherein the adverse event component represents the adverse event;
receiving a first event in response to a first interaction with the adverse event component by the user, wherein the first event indicates that the adverse event is to be reported to the safety compliance management system;
receiving a second event in response to a second interaction with the adverse event component by the user, wherein the second event indicates that the adverse event is ready to be reported to the safety compliance management system;
collecting data that is stored within the electronic data capture system; and
sending the collected data to the safety compliance management system.

2. The computer-readable medium of claim 1,
wherein a timer is initiated to a pre-defined time interval in response to the reception of the first event; and
wherein the sending the collected data further comprises sending the collected data to the safety compliance management system when the pre-defined time interval of the timer elapses before the second event is received.

3. The computer-readable medium of claim 1, wherein the sending the collected data further comprises sending the collected data to the safety compliance management system in near real-time in response to receiving the second event.

4. The computer-readable medium of claim 1,
wherein the adverse event component comprises an adverse event form that is displayed within a user interface of the electronic data capture system;
wherein each interaction of the one or more interactions comprises an entering of data within the adverse event form by the user.

5. The computer-readable medium of claim 4, wherein the first interaction comprises selecting a first displayable element displayed within the adverse event form, wherein the selection of the first displayable element indicates that the adverse event is to be reported to the safety compliance management system.

6. The computer-readable medium of claim 5, wherein the second interaction comprises selecting a second displayable element displayed within the adverse event form, wherein the selection of the second displayable element indicates that the adverse event is ready to be reported to the safety compliance management system.

7. The computer-readable medium of claim 5, wherein the selection of the first displayable element further indicates that the adverse event is a serious adverse event.

8. The computer-readable medium of claim 1, wherein the collected data comprises safety data, wherein the safety data is defined as a subset of the data stored within the electronic data capture system, and wherein the safety data is associated with the adverse event.

9. The computer-readable medium of claim 8, the sending further comprising defining the subset of the data stored within the electronic data capture system by creating a logical schema that defines the subset of the data stored within the electronic data capture system.

10. The computer-readable medium of claim 1, wherein the collected data comprises data associated with a clinical trial; and
wherein the adverse event comprises an adverse event associated with the clinical trial.

11. A computer-implemented method for sending data to a safety compliance management system in response to an adverse event, the computer-implemented method comprising:
monitoring one or more interactions with an adverse event component by a user of an electronic data capture system, wherein the adverse event component represents the adverse event;
receiving a first event in response to a first interaction with the adverse event component by the user, wherein the first event indicates that the adverse event is to be reported to the safety compliance management system;
receiving a second event in response to a second interaction with the adverse event component by the user, wherein the second event indicates that the adverse event is ready to be reported to the safety compliance management system;
collecting data that is stored within the electronic data capture system; and
sending the collected data to the safety compliance management system.

12. The computer-implemented method of claim 11,
wherein a timer is initiated to a pre-defined time interval in response to the reception of the first event; and
wherein the sending the collected data further comprises sending the collected data to the safety compliance management system when the pre-defined time interval of the timer elapses before the second event is received.

13. The computer-implemented method of claim 11, wherein the sending the collected data further comprises sending the collected data to the safety compliance management system in near real-time in response to receiving the second event.

14. The computer-implemented method of claim 11,
wherein the adverse event component comprises an adverse event form that is displayed within a user interface of the electronic data capture system;
wherein each interaction of the one or more interactions comprises an entering of data within the adverse event form by the user.

15. The computer-implemented method of claim 14, wherein the first interaction comprises selecting a first displayable element displayed within the adverse event form, wherein the selection of the first displayable element indicates that the adverse event is to be reported to the safety compliance management system.

16. A system for sending data related to an adverse event to a safety compliance management system, the system comprising:
a processor;
a memory configured to store one or more instructions;
a monitoring module configured to monitor one or more interactions with an adverse event component by a user of an electronic data capture system, wherein the adverse event component represents the adverse event;
a first event receiving module configured to receive a first event in response to a first interaction with the adverse event component by the user, wherein the first event indicates that the adverse event is to be reported to the safety compliance management system;
a second event receiving module configured to receive a second event in response to a second interaction with the adverse event component by the user, wherein the second event indicates that the adverse event is ready to be reported to the safety compliance management system;
a collecting module configured to collect data that is stored within the electronic data capture system; and
a sending module configured to send the collected data to the safety compliance management system.

17. The system of claim 16,
wherein the first event receiving module is further configured to initiate a timer to a pre-defined time interval in response to the reception of the first event; and
wherein the sending module is further configured to send the collected data to the safety compliance management system when the pre-defined time interval of the timer elapses before the second event is received.

18. The system of claim 16, wherein the sending module is further configured to send the collected data to the safety compliance management system in near real-time in response to receiving the second event.

19. The system of claim 16,
wherein the adverse event component comprises an adverse event form that is displayed within a user interface of the electronic data capture system;
wherein each interaction of the one or more interactions comprises an entering of data within the adverse event form by the user.

20. The system of claim 19, wherein the first interaction comprises selecting a first displayable element displayed within the adverse event form, wherein the selection of the first displayable element indicates that the adverse event is to be reported to the safety compliance management system.
